(19) United States
(12) Patent Application Publication
(10) Pub. No.: US 2016/0179584 A1
(43) Pub. Date: Jun. 23, 2016

(54) VIRTUAL SERVICE MIGRATION METHOD FOR ROUTING AND SWITCHING PLATFORM AND SCHEDULER

(71) Applicant: Tsinghua University, Beijing (CN)

(72) Inventors: KE XU, Beijing (CN); WEI TAN, Beijing (CN); WENLONG CHEN, Beijing (CN); MENG SHEN, Beijing (CN)

(21) Appl. No.: 14/797,078

(22) Filed: Jul. 11, 2015

(30) Foreign Application Priority Data
Dec. 22, 2014 (CN) 201410806964.5

(51) Int. Cl. G06F 9/50; G06F 9/48

(52) U.S. Cl. CPC G06F 9/5088; G06F 9/4881; G06F 9/5038; G06F 2209/486

(57) ABSTRACT

A virtual service migration method for a routing and switching platform and a scheduler are provided. The virtual service migration method includes: A: obtaining virtual service nodes in the routing and switching platform; B: calculating residual service abilities of the virtual service nodes; C: determining a virtual service node to be migrated and a plurality of object virtual service node from the virtual service nodes according to the residual service abilities; D: determining a plurality of migration costs of the virtual service node to be migrated relative respectively to the plurality of object virtual service nodes, and migrating a job to be migrated from the virtual service node to be migrated to the plurality of object virtual service nodes according to the plurality of migration costs and the residual service abilities.

### CROSS-REFERENCE TO RELATED APPLICATION

This application claims priority to and benefits of Chinese Patent Application No. 201410806964.5, filed with the State Intellectual Property Office of P. R. China on Dec. 22, 2014, the entire contents of which are incorporated herein by reference.

### FIELD

The present disclosure relates to a field of Internet, and more particularly relates to a virtual service migration method for a routing and switching platform, and a scheduler.

### BACKGROUND

With the development of Internet and the openness of protocols and architectures, it is required to update functions supported by a routing and switching platform in real-time, and to extend flexibly a structure of the routing and switching platform. However, contrary to the openness of Internet, a conventional routing and switching system is relatively closed. Based on a commercial object, a network equipment manufacturer keeps structures of network equipments secret, thus strangling scientific institutions. Meanwhile, network equipments manufactured by different manufacturers are different in functions and implementations of interfaces, such that the network equipments manufactured by different manufacturers are incompatible, which is unfavorable for a development of routing and switching equipments and related industries. Therefore, a new generation of routing and switching platforms is required to suit a development of structures of a next generation of network system, to improve a conventional development pattern of the network equipments and to improve a development of a network equipment manufacturing industry. At present there is an open, extensible and reconfigurable routing and switching platform, but there is no virtual service migration strategy corresponding to the open, extensible and reconfigurable routing and switching platform, such that it takes a long time to migrate a job and a resource utilization rate is low.

### SUMMARY

The present disclosure seeks to solve at least one of the above problems.

Accordingly, embodiments of a first aspect of the present disclosure provide a virtual service migration method for a routing and switching platform, including: A: obtaining virtual service nodes in the routing and switching platform; B: calculating residual service abilities of the virtual service nodes; C: determining a virtual service node to be migrated and a plurality of object virtual service node from the virtual service nodes according to the residual service abilities; D: determining a plurality of migration costs of the virtual service node to be migrated relative respectively to the plurality of object virtual service nodes, and migrating a job to be migrated from the virtual service node to be migrated to the plurality of object virtual service nodes according to the migration costs and the residual service abilities.

With the virtual service migration method for a routing and switching platform according to embodiments of the present disclosure, in a dynamic unconventional situation (such as a situation that the routing and switching platform suffers a network attack or a situation that some components on the routing and switching platform lose effectiveness), a time required to migrate a job may be decreased and a resource utilization rate may be increased by using a suitable migration strategy.

In some embodiments, a residual service ability of a virtual service node Nⱼ is calculated according to formula (1):

Rⱼ=P−Sumⱼ (1),

where Rⱼ is the residual service ability of the virtual service node Nⱼ, Sumⱼ is a service ability required to perform all of jobs in the virtual service node Nⱼ, P is a predetermined service ability of the virtual service node Nⱼ, 1≦j≦m, m is a number of the virtual service nodes.

In some embodiments, determining a virtual service node to be migrated includes: judging whether a virtual service node is an invalid node or whether a residual service ability of the virtual service node is less than or equal to a predetermined residual service ability; determining the virtual service node is the virtual service node to be migrated if the virtual service node is the invalid node or the residual service ability of the virtual service node is less than or equal to the predetermined residual service ability.

In some embodiments, migrating a job to be migrated from the virtual service node to be migrated to the plurality of object virtual service nodes according to the migration costs and the residual service abilities includes: D1: selecting a first object virtual service node from the plurality of object virtual service nodes according to the plurality of migration costs and the residual service abilities; D2: migrating a job to be migrated from the virtual service node to be migrated to the first object virtual service node; D3: judging whether there is a job to be migrated in the virtual service node to be migrated; D4: if yes, updating the residual service abilities of the plurality of virtual service nodes, and repeating steps D1-D4.

In some embodiments, a migration cost of a virtual service node Nᵢ relative to a virtual service node Nⱼ is expressed as Cᵢⱼ=(αLᵢⱼ, βBᵢⱼ, γTᵢⱼ, δDᵢⱼ), where 1≦i≦m, 1≦j≦m, i≠j, Cᵢⱼ is the migration cost of the virtual service node Nᵢ relative to the virtual service node Nⱼ is a distance between the virtual service node Nᵢ and the virtual service node Nⱼ, Bᵢⱼ is a bandwidth between the virtual service node Nᵢ and the virtual service node Nⱼ, Tᵢⱼ is a network congestion degree between the virtual service node Nᵢ and the virtual service node Nⱼ, Dᵢⱼ is a cost of recreating the job to be migrated, α, β, γ, δ represent weight coefficients respectively.

In some embodiments, migrating a job to be migrated from the virtual service node to be migrated to the first object virtual service node includes: selecting a shortest job having a greatest emergency degree as a first job to be migrated and determining jobs similar to the first job to be migrated in the virtual service node to be migrated according to attributes of jobs in the virtual service node to be migrated, in which an attribute of a job includes an emergency degree of the job, a length of the job and a type of the job; migrating the first job to be migrated and the jobs similar to the first job to be migrated from the virtual service node to be migrated to the first object virtual service node.

In some embodiments, selecting a first object virtual service node from the plurality of object virtual service nodes according to the plurality of migration costs and the residual service abilities includes: obtaining a plurality of allocation weights of the plurality of object virtual service nodes relative respectively to the virtual service node to be migrated according to the plurality of migration costs and the residual service abilities; selecting an object virtual service node corresponding to a greatest allocation weight as the first object virtual service node.

In some embodiments, an allocation weight of a virtual service node Nᵢ relative to a virtual service node Nⱼ is calculated according to formula (2):

Wᵢⱼ=Rⱼ/Cᵢⱼ (2),

where Wᵢⱼ is the allocation weight of the virtual service node Nᵢ relative to the virtual service node Nⱼ, Rⱼ is the residual service ability of the virtual service node Nᵢ, Cᵢⱼ is the migration cost of the virtual service node Nᵢ relative to the valid virtual service node Nⱼ.

Embodiments of a second aspect of the present disclosure provide a scheduler, including: an obtaining module, configured to obtain virtual service nodes in the routing and switching platform; a calculating module, configured to calculate residual service abilities of the virtual service nodes; a determining module, configured to determine a virtual service node to be migrated and a plurality of object virtual service nodes according to the residual service abilities; a migrating module, configured to determine a plurality of migration costs of the virtual service node to be migrated relative respectively to the plurality of object virtual service nodes, and to migrate a job to be migrated from the virtual service node to be migrated to the plurality of object virtual service nodes according to the plurality of migration costs and the residual service abilities.

In some embodiments, a residual service ability of a virtual service node Nⱼ is calculated according to formula (1):

Rⱼ=P−Sumⱼ (1),

where Rⱼ is the residual service ability of the virtual service node Nⱼ, Sumⱼ is a service ability required to perform all of jobs in the virtual service node Nⱼ, P is a predetermined service ability of the virtual service node Nⱼ, 1≦j≦m, m is a number of the virtual service nodes.

In some embodiments, the determining module is configured to determine a virtual service node to be migrated by steps of: judging whether a virtual service node is an invalid node or whether a residual service ability of the virtual service node is less than or equal to a predetermined residual service ability; determining the virtual service node is the virtual service node to be migrated if the virtual service node is the invalid node or the residual service ability of the virtual service node is less than or equal to the predetermined residual service ability.

In some embodiments, the migrating module includes: a selecting sub-module, configured to select a first object virtual service node from the plurality of object virtual service nodes according to the plurality of migration costs and the residual service abilities; a migrating sub-module, configured to migrate a job to be migrated from the virtual service node to be migrated to the first object virtual service node; a judging sub-module, configured to judge whether there is a job to be migrated in the virtual service node to be migrated; an updating sub-module, configured to update the residual service abilities of the plurality of virtual service nodes.

In some embodiments, a migration cost of a virtual service node Nᵢ relative to a virtual service node Nⱼ is expressed as Cᵢⱼ=(αLᵢⱼ, βBᵢⱼ, γTᵢⱼ, δDᵢⱼ), where 1≦i≦m, 1≦j≦m, i≠j, Cᵢⱼ is the migration cost of the virtual service node Nᵢ relative to the virtual service node Nⱼ, Lᵢⱼ is a distance between the virtual service node Nᵢ and the virtual service node Nⱼ, Bᵢⱼ is a bandwidth between the virtual service node Nᵢ and the virtual service node Nⱼ, Tᵢⱼ is a network congestion degree between the virtual service node Nᵢ and the virtual service node Nⱼ, Dᵢⱼ is a cost of recreating the job to be migrated, α, β, γ, δ represent weight coefficients respectively.

In some embodiments, the selecting sub-module includes: an obtaining unit, configured to obtain a plurality of allocation weights of the plurality of object virtual service nodes relative respectively to the virtual service node to be migrated according to the plurality of migration costs and the residual service abilities; a first selecting unit, configured to select an object virtual service node corresponding to a greatest allocation weight as the object virtual service node.

In some embodiments, the migrating sub-module includes: a second selecting unit, configured to select a shortest job having a greatest emergency degree as a first job to be migrated and to determine jobs similar to the first job to be migrated in the virtual service node to be migrated according to attributes of jobs in the virtual service node to be migrated, in which an attribute of a job includes an emergency degree of the job, a length of the job and a type of the job; a migrating unit, configured to migrate the first job to be migrated and the jobs similar to the first job to be migrated from the virtual service node to be migrated to the object virtual service node.

In some embodiments, an allocation weight of a virtual service node Nᵢ relative to a virtual service node Nⱼ is calculated according to formula (2):

Wᵢⱼ=Rⱼ/Cᵢⱼ (2),

where Wᵢⱼ is the allocation weight of the virtual service node Nᵢ relative to the virtual service node Nⱼ, Rⱼ is the residual service ability of the virtual service node Nᵢ, Cᵢⱼ is the migration cost of the virtual service node Nᵢ relative to the valid virtual service node Nⱼ.

A third aspect of the present disclosure is aimed to provide a computer readable storage medium, comprising a computer program for executing a virtual service migration method for a routing and switching platform according to the first aspect of the present disclosure.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a schematic diagram of an open, extensible and reconfigurable routing and switching platform according to an embodiment of the present disclosure;

FIG. 2 is a flow chart of a virtual service migration method for a routing and switching platform according to an embodiment of the present disclosure;

FIG. 3 is a flow chart of a virtual service migration method for a routing and switching platform according to another embodiment of the present disclosure;

FIG. 4 is a schematic diagram of a virtual service migration platform according to an embodiment of the present disclosure; and

FIG. 5 is a block diagram of a scheduler according to an embodiment of the present disclosure.

### DETAILED DESCRIPTION

Reference will be made in detail to embodiments of the present disclosure, where the same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the description of the present disclosure, it should be understood that, terms such as “first” and “second” are used herein for purposes of description, and are not intended to represent or indicate relative importance or significance or to represent or indicate numbers or locations. In the description of the present disclosure, it should be understood that, unless specified or limited otherwise, terms such as “connected” and “coupled” should be understood broadly, and may be, for example, fixed connections, detachable connections, or integral connections; or may be mechanical or electrical connections; or may be direct connections or indirect connections via intervening structures, which can be understood by those skilled in the art according to specific situations. Moreover, in the description of the present invention, unless specified otherwise, “a plurality of” means two or more than two.

Any process or method described in a flow chart or described herein in other ways may be understood to include one or more modules, segments or portions of codes of executable instructions for achieving specific logical functions or steps in the process. Although the flow chart shows a specific order of execution, it is understood that the order of execution may differ from what is depicted. For example, the order of execution of two or more boxes may be scrambled relative to the order shown.

In the following, a virtual service migration method for a routing and switching platform according to embodiments of the present disclosure will be described in detail with reference to drawings.

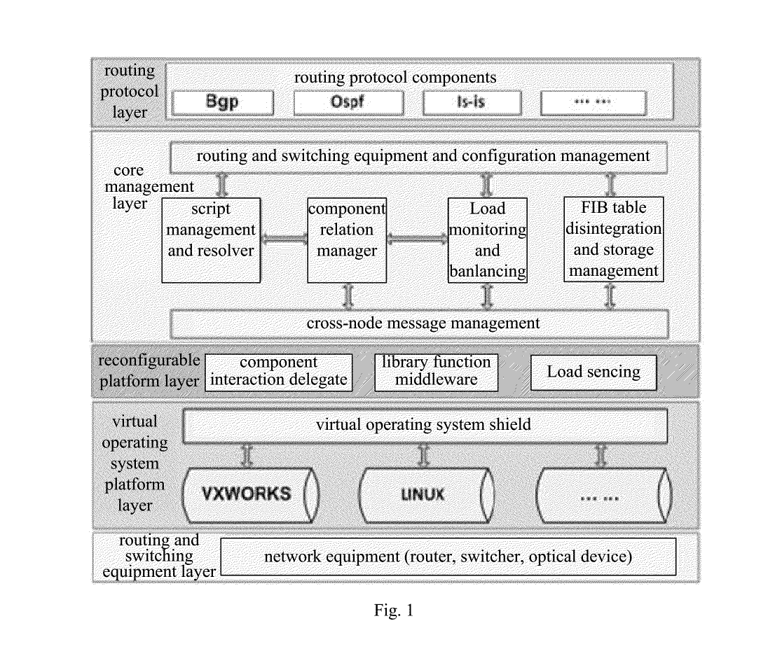

FIG. 1 is a schematic diagram of an open, extensible and reconfigurable routing and switching platform according to an embodiment of the present disclosure. As shown in FIG. 1, there are five layers in the open, extensible and reconfigurable routing and switching platform.

A routing and switching equipment layer is at the bottom, the routing and switching equipment layer is a physical hardware platform of network equipments. A virtual operating system platform layer is above the routing and switching equipment layer, configured to shield differences between different operating systems by calling an integration system, thus improving an adaptability of the routing and switching platform. A reconfigurable platform layer is above the virtual operating system platform layer, configured to implement a dynamic loading/unloading of a software component with respect to various routing operating system and to update a connected relation of internal modules. A core management layer is above the reconfigurable platform layer, comprising a perfect cluster management strategy. With the cluster management strategy, a complexity of a device management and a complexity of a topology maintenance of a whole extensible routing and switching equipment cluster are as same as that of a single node. A data integrity protection of a real-time migration job may be provided and an efficient way of controlling an assignment of jobs and a message communication mechanism between nodes may be implemented by the core management layer by using a method of separating contents and relations, such that the cluster may achieve load balancing and extra-cost of the cluster is small, thus improving a performance and a transferring efficiency of the cluster greatly. A routing protocol layer is at the top, supporting various routing protocols, such as OSPF (Open Shortest Path First), BGP (Border Gateway Protocol) and so on.

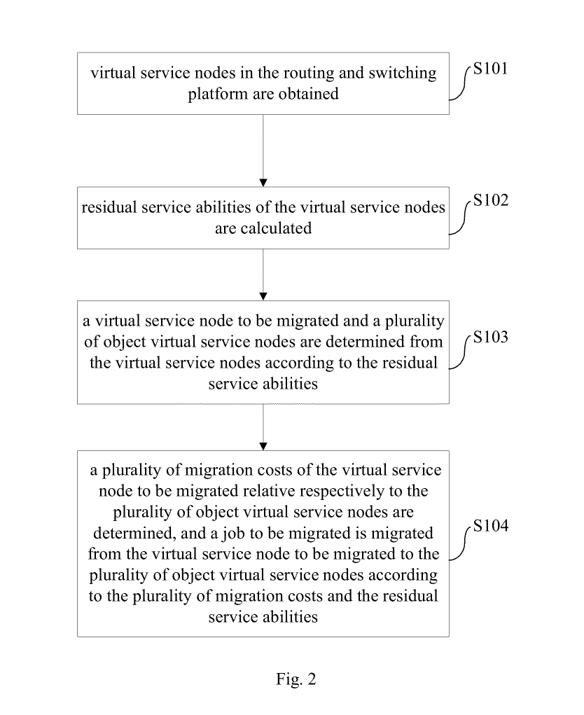

FIG. 2 is a flow chart of a virtual service migration method for a routing and switching platform according to an embodiment of the present disclosure. Referring to FIG. 2, the virtual service migration method for a routing and switching platform includes following steps.

At step S101, virtual service nodes in the routing and switching platform are obtained. Let Nⱼ denote a virtual service node, where 1≦j≦m, m is a number of the virtual service nodes.

At step S102, residual service abilities of the virtual service nodes are calculated.

In some embodiments, a residual service ability of a virtual service node Nⱼ may be calculated according to formula (1).

Rⱼ=P−Sumⱼ (1),

Rⱼ is the residual service ability of virtual service node Nⱼ, Sumⱼ is a service ability required to perform all of jobs in the virtual service node Nⱼ, P is a predetermined service ability of the virtual service node Nⱼ.

At step S103, a virtual service node to be migrated and a plurality of object virtual service nodes are determined from the virtual service nodes according to the residual service abilities.

Specifically, the step of determining a virtual service node to be migrated may include following steps.

(1) it is judged whether a virtual service node is an invalid node or whether a residual service ability of the virtual service node is less than or equal to a predetermined residual service ability;

(2) it is determined the virtual service node is the virtual service node to be migrated if the virtual service node is the invalid node or the residual service ability of the virtual service node is less than or equal to the predetermined residual service ability.

Specifically, it is judged whether the virtual service node is invalid. An invalid virtual service node may lose effectiveness because the fact that the virtual service node suffers a network attack or a component in the virtual service node is invalid. If the virtual service node is invalid, the virtual service node is the virtual service node to be migrated, else it is judged whether the residual service ability of the virtual service node is less than or equal to the predetermined residual service ability. If the residual service ability of the virtual service node is less than or equal to the predetermined residual service ability, the virtual service node cannot provide service for a job, that is, the virtual service node is the virtual service node to be migrated, else the virtual service node is an object virtual service node. A job in the virtual service node to be migrated may be migrated to the object virtual service node.

In other words, in a dynamic unconventional situation, the virtual service node may lose effectiveness because the fact that the virtual service node suffers the network attack or the component in the virtual service node is invalid. The virtual service nodes may be polled periodically so as to find the invalid node. Meanwhile, some virtual service nodes are valid, but the residual service abilities are limited, these virtual service nodes with residual service abilities less than the predetermined residual service ability cannot provide services, thus these virtual service nodes with residual service abilities less than the predetermined residual service ability are defined as the virtual service nodes to be migrated.

At step S104, a plurality of migration costs of the virtual service node to be migrated relative respectively to the plurality of object virtual service nodes are determined, and a job to be migrated is migrated from the virtual service node to be migrated to the plurality of object virtual service nodes according to the plurality of migration costs and the residual service abilities.

Specifically, a migration cost of a virtual service node Nᵢ relative to a virtual service node Nⱼ is expressed as Cᵢⱼ=(αLᵢⱼ, βBᵢⱼ, γTᵢⱼ, δDᵢⱼ), where 1≦i≦m, 1≦j≦m, i≠j, Cᵢⱼ is the migration cost of the virtual service node Nᵢ relative to the virtual service node Nⱼ, Bᵢⱼ is a distance between the virtual service node Nᵢ and the virtual service node Nⱼ, Bᵢⱼ is a bandwidth between the virtual service node Nᵢ and the virtual service node Nⱼ, Tᵢⱼ is a network congestion degree between the virtual service node Nᵢ and the virtual service node Nⱼ, Dᵢⱼ is a cost of recreating the job to be migrated, α, β, γ, δ represent weight coefficients respectively. Obviously, the smaller the distance Lᵢⱼ, the bigger the bandwidth Bᵢⱼ, the lower the network congestion degree Tᵢⱼ, the smaller the cost Dᵢⱼ recreating the job to be migrated, the smaller the migration cost Cᵢⱼ is.

In an embodiment, a migration cost between each two virtual service nodes may be calculated periodically and be updated by a scheduler since the network congestion degree between each two virtual service nodes is dynamic. Specifically, if a time period T is set, the each two virtual service nodes may send probe packets to each other at intervals of T to determine the migration cost between the each two virtual service nodes, and the migration cost may be reported to the scheduler.

In an embodiment, a step of migrating a job to be migrated from the virtual service node to be migrated to the plurality of object virtual service nodes according to the migration costs and the residual service abilities may include following steps.

At step S41, a first object virtual service node is selected from the plurality of object virtual service nodes according to the plurality of migration costs and the residual service abilities.

In an embodiment, a step of selecting a first object virtual service node from the plurality of object virtual service nodes according to the plurality of migration costs and the residual service abilities may include following steps.

(1) a plurality of allocation weights of the plurality of object virtual service nodes relative respectively to the virtual service node to be migrated are obtained according to the plurality of migration costs and the residual service abilities.

An allocation weight of the virtual service node Nᵢ relative to the virtual service node Nⱼ may be calculated according to formula (2):

Wᵢⱼ=Rⱼ/Cᵢⱼ (2),

where Wᵢⱼ is the allocation weight of the virtual service node Nᵢ relative to the virtual service node Nⱼ, Rⱼ is the residual service ability of the virtual service node Nᵢ, Cᵢⱼ is the migration cost of the virtual service node Nᵢ relative to the valid virtual service node Nⱼ. Obviously, the bigger the residual service ability of virtual service node Nⱼ, the smaller the migration cost of the virtual service node Nᵢ relative to the virtual service node Nⱼ, the bigger the allocation weight of the virtual service node Nᵢ relative to the virtual service node Nⱼ is, in other words, the bigger the allocation weight of getting by the virtual service node Nⱼ a job from the virtual service node Nᵢ is.

(2) an object virtual service node corresponding to a greatest allocation weight is selected as the first object virtual service node.

Allocation weights of all the object virtual service nodes are calculated, and then the object virtual service node corresponding to the greatest allocation weight is selected as the first object virtual service node, and a job to be migrated in the virtual service node to be migrated is migrated to the first object virtual service node firstly.

At step S42, a job to be migrated is migrated from the virtual service node to be migrated to the first object virtual service node.

In an embodiment, a step of migrating a job to be migrated from the virtual service node to be migrated to the first object virtual service node may include following steps.

(1) a shortest job having a greatest emergency degree is selected as a first job to be migrated and jobs similar to the first job to be migrated in the virtual service node to be migrated are determined according to attributes of jobs in the virtual service node to be migrated, in which an attribute of a job includes an emergency degree of the job, a length of the job and a type of the job.

Specifically, each job has an attribute list configured to describe attributes of the each job. The attributes include the emergency degree of the job, the length of the job (service ability required to perform the job), and the type of the job and so on. A similarity between each two jobs may be calculated according to attribute lists of the each two jobs, such that a set including similar jobs of each job may be obtained. Similar jobs may be migrated to a same virtual service node.

A job is selected from the plurality of jobs to be migrated as the first job to be migrated according to a weighted shortest job first algorithm. Specifically, jobs having a greatest emergency degree are selected from the plurality of jobs to be migrated, and then a shortest job is selected from the jobs having a greatest emergency degree as the first job to be migrated. After the first job to be migrated is determined, jobs similar to the first job to be migrated are selected from the set including similar jobs of the first job to be migrated. Specifically, after the first job to be migrated is determined, the set including similar jobs of the first job to be migrated is checked and if the similarity of a job in the set including similar jobs of the first job to be migrated and the first job to be migrated is greater than a predetermined threshold, this job may be selected and be migrated with the first job to be migrated at the same time.

(2) the first job to be migrated and the jobs similar to the first job to be migrated are migrated from the virtual service node to be migrated to the first object virtual service node.

At step S43, it is judged whether there is a job to be migrated in the virtual service node to be migrated.

At step S44, if yes, the residual service abilities of the plurality of virtual service nodes are updated, and steps S41-S44 are repeated.

If a job is migrated from the virtual service node Nᵢ to the virtual service node Nⱼ, the residual service ability of the virtual service node Nⱼ may be updated according to formula (3).

Rⱼ′=Rⱼ−lᵢⱼ (3),

where Rⱼ′ is an updated residual service ability of the virtual service node Nⱼ, Rⱼ is the residual service ability of the virtual service node Nⱼ, lᵢⱼ is a service ability required to perform the job migrated from the virtual service node Nᵢ.

If the updated residual service ability of the virtual service node Nⱼ is less than a second predetermined residual service ability Φ(Rⱼ′<Φ), the virtual service node Nⱼ is no longer an object virtual service node, that is, no job can be migrated to the virtual service node Nⱼ.

If there are still jobs to be migrated in the virtual service node to be migrated, steps S41-S44 are repeated to migrate these jobs to be migrated.

In some embodiments, if a job in an object service node is finished, a residual service ability of the object service node may be updated.

If a job t in the virtual service node Nⱼ is finished, a next job in a job list in the virtual service node Nⱼ may be performed. The next job may be selected from the job list according to FCFS (First Come First Served) algorithm. The residual service of the virtual service node Nⱼ may be calculated according to formula (4).

Rⱼ′=Rⱼ−tᵢⱼ (4),

where Rⱼ′ is an updated residual service ability of the virtual service node Nⱼ, Rⱼ is the residual service ability of the virtual service node Nⱼ, tᵢⱼ is a service ability required to perform the job t. If the updated residual service ability of the virtual service node Nⱼ is greater than the second predetermined residual service ability Φ (Rⱼ′>Φ), the virtual service node Nⱼ is an object virtual service node, that is, a job can be migrated to the virtual service node Nⱼ.

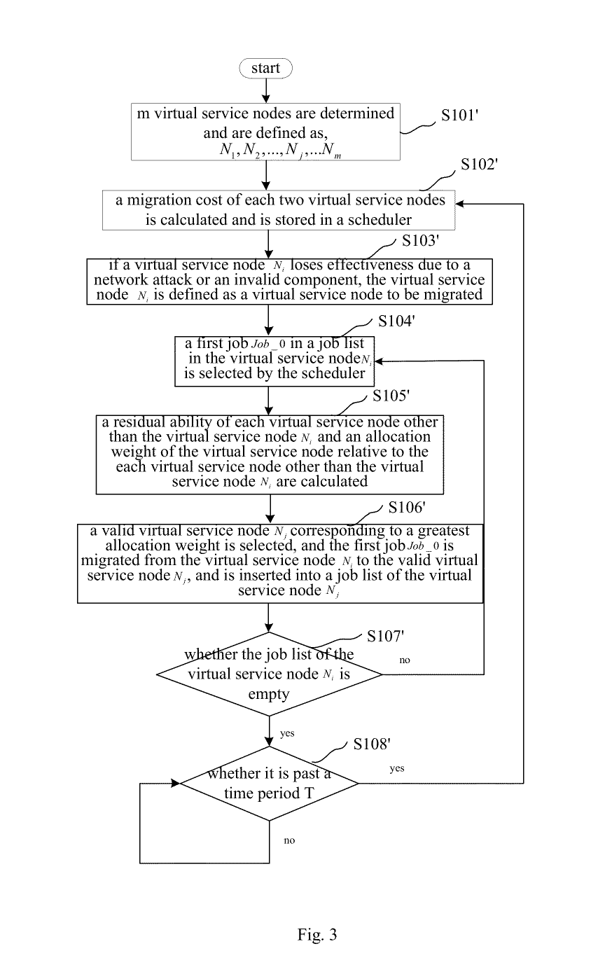

FIG. 3 is a flow chart of a virtual service migration method for a routing and switching platform according to another embodiment of the present disclosure. Referring to FIG. 3, there is a specific example according to embodiments of the present disclosure.

At step S101′, m virtual service nodes in the routing and switching platform are determined, which are denoted as N₁, N₂, . . . , Nⱼ, . . . Nₘ.

At step S102′, a migration cost of each two virtual service nodes is calculated and is stored in a scheduler.

It should be noted that the migration cost between each two virtual service nodes is calculated periodically, so this step may be executed in the routing and switching platform periodically.

At step S103′, if a virtual service node Nᵢ loses effectiveness due to a network attack or an invalid component, the virtual service node Nᵢ is defined as a virtual service node to be migrated.

At step S104′, a first job Job_0 in a job list in the virtual service node Nᵢ is selected by the scheduler.

At step S105′, a residual ability of each virtual service node other than the virtual service node Nᵢ and an allocation weight of the virtual service node Nᵢ relative to the each virtual service node other than the virtual service node Nᵢ are calculated.

At step S106′, a valid virtual service node Nⱼ corresponding to a greatest allocation weight is selected, and the first job Job_0 is migrated from the virtual service node Nᵢ to the valid virtual service node Nⱼ, and is inserted into a job list of the virtual service node Nⱼ.

At step S107′, it is determined whether the job list of the virtual service node Nᵢ is empty.

If the job list of the virtual service node Nᵢ is not empty, it is returned to step S104′, or else, step S108′ is followed.

At step S108′, it is determined whether it is past a time period T, in which the time period T is a period for calculating the migration cost.

If it is past the time period of T, it is returned to step S102′, or else it is returned to step S108′ to wait until it is past the time period of T.

It should be noted that the migration of the virtual service node Nᵢ is descripted in this example, if there are other virtual service nodes losing effectiveness or with the residual service abilities less than the predetermined residual service ability in the routing and switching platform, the above-descripted steps may be executed repeatedly.

FIG. 4 is a schematic diagram of a virtual service migration platform according to an embodiment of the present disclosure. As shown in FIG. 4, there are m virtual service nodes Nⱼ in a routing and switching platform. A scheduler of a virtual operating system is configured to schedule jobs. The scheduler may communicate with each virtual service node, and a migration cost of virtual service node Nᵢ relative to virtual service node Nⱼ is saved in the scheduler. Each virtual service node has a job list, and jobs in the job list are performed by each virtual service node according to FCFS algorithm.

With the virtual service migration method for a routing and switching platform according to embodiments of the present disclosure, in a dynamic unconventional situation (such as a situation that the routing and switching platform suffers a network attack or a situation that some components on the routing and switching platform lose effectiveness), a time required to migrate a job may be decreased and a resource utilization rate may be increased by using a suitable migration strategy.

A scheduler according to embodiments of the present disclosure will be described in detail with reference to drawings.

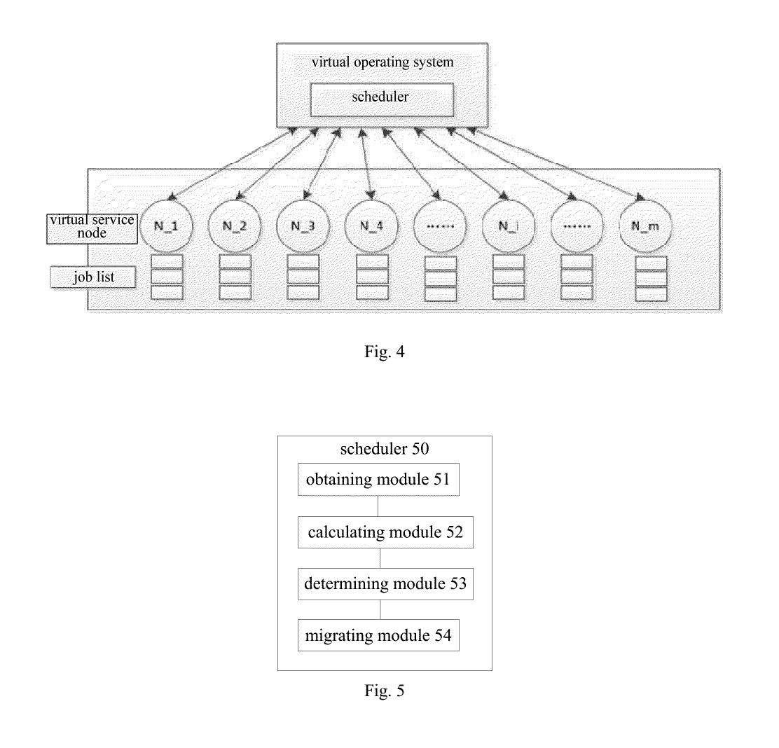

FIG. 5 is a block diagram of a scheduler according to an embodiment of the present disclosure. As shown in FIG. 5, the scheduler 50 includes an obtaining module 51, a calculating module 52, a determining module 53, and a migrating module 54.

The obtaining module 51 is configured to obtain virtual service nodes in the routing and switching platform.

The calculating module 52 is configured to calculate residual service abilities of the virtual service nodes.

The determining module 53 is configured to determine a virtual service node to be migrated and a plurality of object virtual service nodes according to the residual service abilities.

The migrating module 54 is configured to determine a plurality of migration costs of the virtual service node to be migrated relative respectively to the plurality of object virtual service nodes, and to migrate a job to be migrated from the virtual service node to be migrated to the plurality of object virtual service nodes according to the plurality of migration costs and the residual service abilities.

In some embodiments, a residual service ability of a virtual service node Nⱼ is calculated according to formula (1):

Rⱼ=P−Sumⱼ (1),

where Rⱼ is the residual service ability of the virtual service node Nⱼ, Sumⱼ is a service ability required to perform all of jobs in the virtual service node Nⱼ, P is a predetermined service ability of the virtual service node Nⱼ, 1≦j≦m, m is a number of the virtual service nodes.

In some embodiments, the determining module is configured to determine a virtual service node to be migrated by steps of: judging whether a virtual service node is an invalid node or whether a residual service ability of the virtual service node is less than or equal to a predetermined residual service ability; determining the virtual service node is the virtual service node to be migrated if the virtual service node is the invalid node or the residual service ability of the virtual service node is less than or equal to the predetermined residual service ability.

In some embodiments, the migrating module includes: a selecting sub-module, configured to select a first object virtual service node from the plurality of object virtual service nodes according to the plurality of migration costs and the residual service abilities; a migrating sub-module, configured to migrate a job to be migrated from the virtual service node to be migrated to the first object virtual service node; a judging sub-module, configured to judge whether there is a job to be migrated in the virtual service node to be migrated; an updating sub-module, configured to update the residual service abilities of the plurality of virtual service nodes.

In some embodiments, a migration cost of a virtual service node Nᵢ relative to a virtual service node Nⱼ is expressed as Cᵢⱼ=(αLᵢⱼ, βBᵢⱼ, γTᵢⱼ, δDᵢⱼ), where 1≦i≦m, 1≦j≦m, i≠j, Cᵢⱼ is the migration cost of the virtual service node Nᵢ relative to the virtual service node Nⱼ, Lᵢⱼ is a distance between the virtual service node Nᵢ and the virtual service node Nⱼ, Bᵢⱼ is a bandwidth between the virtual service node Nᵢ and the virtual service node Nⱼ, Tᵢⱼ is a network congestion degree between the virtual service node Nᵢ and the virtual service node Nⱼ, Dᵢⱼ is a cost of recreating the job to be migrated, α, β, γ, δ represent weight coefficients respectively.

In some embodiments, the selecting sub-module includes: an obtaining unit, configured to obtain a plurality of allocation weights of the plurality of object virtual service nodes relative respectively to the virtual service node to be migrated according to the plurality of migration costs and the residual service abilities; a first selecting unit, configured to select an object virtual service node corresponding to a greatest allocation weight as the first object virtual service node.

In some embodiments, the migrating sub-module includes: a second selecting unit, configured to select a shortest job having a greatest emergency degree as a first job to be migrated and to determine jobs similar to the first job to be migrated in the virtual service node to be migrated according to attributes of jobs in the virtual service node to be migrated, in which an attribute of a job includes an emergency degree of the job, a length of the job and a type of the job; a migrating unit, configured to migrate the first job to be migrated and the jobs similar to the first job to be migrated from the virtual service node to be migrated to the first object virtual service node.

In some embodiments, an allocation weight of a virtual service node Nᵢ relative to a virtual service node Nⱼ is calculated according to formula (2):

Wᵢⱼ=Rⱼ/Cᵢⱼ (2),

where Wᵢⱼ is the allocation weight of the virtual service node Nᵢ relative to the virtual service node Nⱼ, Rⱼ is the residual service ability of the virtual service node Nᵢ, Cᵢⱼ is the migration cost of the virtual service node Nᵢ relative to the valid virtual service node Nⱼ.

A computer readable storage medium is provided, comprising a computer program for executing the virtual service migration method for a routing and switching platform according to the above-descripted.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A virtual service migration method for a routing and switching platform, comprising:
A: obtaining virtual service nodes in the routing and switching platform;
B: calculating residual service abilities of the virtual service nodes;
C: determining a virtual service node to be migrated and a plurality of object virtual service node from the virtual service nodes according to the residual service abilities;
D: determining a plurality of migration costs of the virtual service node to be migrated relative respectively to the plurality of object virtual service nodes, and migrating a job to be migrated from the virtual service node to be migrated to the plurality of object virtual service nodes according to the plurality of migration costs and the residual service abilities.

2. The method according to claim 1, wherein a residual service ability of a virtual service node Nⱼ is calculated according to formula (1):
Rⱼ=P−Sumⱼ (1),
where Rⱼ is the residual service ability of the virtual service node Nⱼ, Sumⱼ is a service ability required to perform all of jobs in the virtual service node Nⱼ, P is a predetermined service ability of the virtual service node Nⱼ, 1≦j≦m, m is a number of the virtual service nodes.

3. The method according to claim 1, wherein determining a virtual service node to be migrated comprises:
judging whether a virtual service node is an invalid node or whether a residual service ability of the virtual service node is less than or equal to a predetermined residual service ability;
determining the virtual service node is the virtual service node to be migrated if the virtual service node is the invalid node or the residual service ability of the virtual service node is less than or equal to the predetermined residual service ability.

4. The method according to claim 1, wherein migrating a job to be migrated from the virtual service node to be migrated to the plurality of object virtual service nodes according to the plurality of migration costs and the residual service abilities comprises:
D1: selecting a first object virtual service node from the plurality of object virtual service nodes according to the plurality of migration costs and the residual service abilities;
D2: migrating a job to be migrated from the virtual service node to be migrated to the first object virtual service node;
D3: judging whether there is a job to be migrated in the virtual service node to be migrated;
D4: if yes, updating the residual service abilities of the plurality of virtual service nodes, and repeating steps D1-D4.

5. The method according to claim 4, wherein a migration cost of a virtual service node Nᵢ relative to a virtual service node Nⱼ is expressed as Cᵢⱼ=(αLᵢⱼ, βBᵢⱼ, γTᵢⱼ, δDᵢⱼ), where 1≦i≦m, 1≦j≦m, i≠j, Cᵢⱼ is the migration cost of the virtual service node Nᵢ relative to the virtual service node Nⱼ, Lᵢⱼ is a distance between the virtual service node Nᵢ and the virtual service node Nⱼ, Bᵢⱼ is a bandwidth between the virtual service node Nᵢ and the virtual service node Nⱼ, Tᵢⱼ is a network congestion degree between the virtual service node Nᵢ and the virtual service node Nⱼ, Dᵢⱼ is a cost of recreating the job to be migrated, α, β, γ, δ represent weight coefficients respectively.

6. The method according to claim 4, wherein migrating a job to be migrated from the virtual service node to be migrated to the first object virtual service node comprises:
selecting a shortest job having a greatest emergency degree as a first job to be migrated and determining jobs similar to the first job to be migrated in the virtual service node to be migrated according to attributes of jobs in the virtual service node to be migrated, wherein an attribute of a job comprises an emergency degree of the job, a length of the job and a type of the job;
migrating the first job to be migrated and the jobs similar to the first job to be migrated from the virtual service node to be migrated to the first object virtual service node.

7. The method according to claim 5, wherein selecting a first object virtual service node from the plurality of object virtual service nodes according to the plurality of migration costs and the residual service abilities comprise:
obtaining a plurality of allocation weights of the plurality of object virtual service nodes relative respectively to the virtual service node to be migrated according to the plurality of migration costs and the residual service abilities;
selecting an object virtual service node corresponding to a greatest allocation weight as the first object virtual service node.

8. The method according to claim 7, wherein an allocation weight of a virtual service node Nᵢ relative to a virtual service node Nⱼ is calculated according to formula (2):
Wᵢⱼ=Rⱼ/Cᵢⱼ (2),
where Wᵢⱼ is the allocation weight of the virtual service node Nᵢ relative to the virtual service node Nⱼ, Rⱼ is the residual service ability of the virtual service node Nᵢ, Cᵢⱼ is the migration cost of the virtual service node Nᵢ relative to the valid virtual service node Nⱼ.

9. A scheduler, comprising:
an obtaining module, configured to obtain virtual service nodes in the routing and switching platform;
a calculating module, configured to calculate residual service abilities of the virtual service nodes;
a determining module, configured to determine a virtual service node to be migrated and a plurality of object virtual service nodes according to the residual service abilities;
a migrating module, configured to determine a plurality of migration costs of the virtual service node to be migrated relative respectively to the plurality of object virtual service nodes, and to migrate a job to be migrated from the virtual service node to be migrated to the plurality of object virtual service nodes according to the plurality of migration costs and the residual service abilities.

10. The scheduler according to claim 9, wherein a residual service ability of a virtual service node Nⱼ is calculated according to formula (1):
Rⱼ=P−Sumⱼ (1),
where Rⱼ is the residual service ability of the virtual service node Nⱼ, Sumⱼ is a service ability required to perform all of jobs in the virtual service node Nⱼ, P is a predetermined service ability of the virtual service node Nⱼ, 1≦j≦m, m is a number of the virtual service nodes.

11. The scheduler according to claim 9, wherein the determining module is configured to determine a virtual service node to be migrated by steps of:
judging whether a virtual service node is an invalid node or whether a residual service ability of the virtual service node is less than or equal to a predetermined residual service ability;
determining the virtual service node is the virtual service node to be migrated if the virtual service node is the invalid node or the residual service ability of the virtual service node is less than or equal to the predetermined residual service ability.

12. The scheduler according to claim 9, wherein the migrating module comprises:
a selecting sub-module, configured to select a first object virtual service node from the plurality of object virtual service nodes according to the plurality of migration costs and the residual service abilities;
a migrating sub-module, configured to migrate a job to be migrated from the virtual service node to be migrated to the first object virtual service node;
a judging sub-module, configured to judge whether there is a job to be migrated in the virtual service node to be migrated;
an updating sub-module, configured to update the residual service abilities of the plurality of virtual service nodes.

13. The scheduler according to claim 12, wherein a migration cost of a virtual service node Nᵢ relative to a virtual service node Nⱼ is expressed as Cᵢⱼ=(αLᵢⱼ, βBᵢⱼ, γTᵢⱼ, δDᵢⱼ), where 1≦i≦m, 1≦j≦m, i≠j, Cᵢⱼ is the migration cost of the virtual service node Nᵢ relative to the virtual service node Nⱼ, Lᵢⱼ is a distance between the virtual service node Nᵢ and the virtual service node Nⱼ, Bᵢⱼ is a bandwidth between the virtual service node Nᵢ and the virtual service node Nⱼ, Tᵢⱼ is a network congestion degree between the virtual service node Nᵢ and the virtual service node Nⱼ, Dᵢⱼ is a cost of recreating the job to be migrated, α, β, γ, δ represent weight coefficients respectively.

14. The scheduler according to claim 13, wherein the selecting sub-module comprises:
an obtaining unit, configured to obtain a plurality of allocation weights of the plurality of object virtual service nodes relative respectively to the virtual service node to be migrated according to the plurality of migration costs and the first residual service abilities;
a first selecting unit, configured to select an object virtual service node corresponding to a greatest allocation weight as the first object virtual service node.

15. The scheduler according to claim 12, wherein the migrating sub-module comprises:
a second selecting unit, configured to select a shortest job having a greatest emergency degree as a first job to be migrated and to determine jobs similar to the first job to be migrated in the virtual service node to be migrated according to attributes of jobs in the virtual service node to be migrated, wherein an attribute of a job comprises an emergency degree of the job, a length of the job and a type of the job;
a migrating unit, configured to migrate the first job to be migrated and the jobs similar to the first job to be migrated from the virtual service node to be migrated to the object virtual service node.

16. The scheduler according to claims 15, wherein an allocation weight of a virtual service node Nᵢ relative to a virtual service node Nⱼ is calculated according to formula (2):
Wᵢⱼ=Rⱼ/Cᵢⱼ (2),
where Wᵢⱼ is the allocation weight of the virtual service node Nᵢ relative to the virtual service node Nⱼ, Rⱼ is the residual service ability of the virtual service node Nᵢ, Cᵢⱼ is the migration cost of the virtual service node Nᵢ relative to the valid virtual service node Nⱼ.

17. A computer readable storage medium, comprising a computer program for executing a virtual service migration method for a routing and switching platform, wherein the virtual service migration method comprises:
A: obtaining virtual service nodes in the routing and switching platform;
B: calculating residual service abilities of the virtual service nodes;
C: determining a virtual service node to be migrated and a plurality of object virtual service node from the virtual service nodes according to the residual service abilities;
D: determining a plurality of migration costs of the virtual service node to be migrated relative respectively to the plurality of object virtual service nodes, and migrating a job to be migrated from the virtual service node to be migrated to the plurality of object virtual service nodes according to the plurality of migration costs and the residual service abilities.
